(19) United States
(12) Patent Application Publication
(10) Pub. No.: US 2010/0260380 A1
(43) Pub. Date: Oct. 14, 2010

(54) DEVICE FOR OPTICALLY MEASURING AND/OR TESTING OBLONG PRODUCTS

(75) Inventors: Beda Kaeser, Bruegg (CH); Daniel Berard, Scheuren (CH)

Correspondence Address: VENABLE LLP, P.O. BOX 34385, WASHINGTON, DC, 20043-9998, US

(73) Assignee: Zumbach Electronic AG, Orpund (CH)

(21) Appl. No.: 12/739,056

(22) PCT Filed: Oct. 23, 2008
(86) PCT No.: PCT/EP2008/008970

§ 371 Date: Apr. 21, 2010

(30) Foreign Application Priority Data
Oct. 23, 2007 (EP) 07020721.2

(51) Int. Cl. G06K 9/00; H04N 7/18

(52) U.S. Cl. 382/103; 348/135; 348/E07.085

(57) ABSTRACT

A device for optically measuring and/or testing oblong products moving in a longitudinal direction. The device includes a plurality of cameras arranged in a plane perpendicular to the longitudinal direction, and distributed around the longitudinal direction. Each of the cameras has a fixed focus. The device further includes a displacing device adapted to displace each of the cameras simultaneously and jointly over the same distance toward the surface of the oblong product to focus on the oblong product, wherein the device defines a center that is located in the plane.

### CROSS-REFERENCE TO RELATED APPLICATIONS

This application is the national stage of International Application No. PCT/EP2008/008970, filed on Oct. 23, 2008, which designates the United States and claims priority to European Application No. EP 07020721.2, filed on Oct. 23, 2007. The entire contents of the aforementioned applications are incorporated herein by reference in their entirety.

### TECHNICAL FIELD

The invention relates to a device for optically measuring and/or testing oblong products, moving forward in their longitudinal direction, with the aid of a plurality of cameras which can be moved in the direction toward the surface of the oblong product for the focus-setting of the image. The invention furthermore relates to a corresponding method.

### BACKGROUND

Already known are the techniques of an optically precise measuring of geometries, in particular the geometry of oblong products moving forward in longitudinal direction, as well as the detection and/or measuring of defect locations on these types of products. One requirement for a precise measuring of this type is that the sharpness of focus of the camera used for the measuring operation must be optimally adjusted. The distortion must furthermore be minimal and the precise image scale must be known.

However, if one and the same measuring system is used for differently shaped and/or differently dimensioned products, and thus for different distances between the camera and the measuring plane, for example to the surface of the structure to be measured, the above-described requirements can only be met with difficulty.

Devices of the aforementioned type are already known which are provided with an autofocus optics that permits without problems a quick and precise adjustment of the required sharpness of focus. However, the required adjustment of the optical elements also results in a corresponding change in the image scale which negatively influences a precise measurement.

To obtain a precise measurement when using prior art devices with autofocus optics, a new calibration is required for each distance between the camera and the object or the product to be measured.

For a precise measurement, it is furthermore necessary to take into account the image distortion caused by lens aberrations. As is known, these aberrations are not constant for different adjustments when using an optical system. The degree of the distortion consequently also depends on the respective focus setting.

As a result, the correction algorithms for compensating the distortion errors are therefore valid only for a specific focus setting. Accordingly, for a system of this type an associated set of correction data for compensating the distortion would have to be determined and stored for each focus setting in addition to the image scale. This requires a lot of time and is correspondingly expensive.

The document JP-A-7 311 161 discloses a device for the optical measuring and/or testing of oblong products moving forward in their longitudinal direction, said device comprising at least one camera with focus setting of the image, wherein the camera can be displaced in the direction toward the surface of the oblong product for the focus setting of the image.

The document JP-A-2001 337 046 also discloses a device for the optical measuring and/or testing of oblong products moving forward in their longitudinal direction, said device comprising at least one camera with focus setting of the image. Several movable cameras are used with this device.

### SUMMARY

It is the object of the present invention to provide a simple and cost-effective device of the generic type with focus setting of the image. It is furthermore the object of the present invention to provide a cost-effective and simple method for realizing the optical measuring and/or testing of the aforementioned type.

This object is solved with the teaching disclosed in the independent claims.

The device according to the invention uses several cameras having a fixed focus which can be moved jointly and simultaneously by the same distance with the aid of a single device.

With the device according to the invention, all cameras are thus moved or displaced in the direction of the surface, in particular in perpendicular direction toward the surface of the oblong product to be measured. Naturally, the cameras are moved advantageously to a location at an optimum distance to the object surface or the product surface to be measured.

The focus setting of the image in the camera is therefore not achieved through an adjustment of the optics (autofocus). Rather, a cost-effective and simply designed camera with standard optics, which consequently has a long service life, can be used for the measuring operation. A camera of this type has a fixed focus. The measurements obtained with this camera can be provided with an unambiguous distortion correction value.

The device according to the invention therefore in particular has the following advantages:
the enlargement factor remains absolutely constant;
the fixedly calibrated distortion correction permits optimum measuring conditions for each setting; and
this results in a higher repeatability and accuracy for the measurements carried out.

The above-mentioned advantages have an effect because several cameras are used for realizing the measuring tasks to be performed. The device according to the invention is therefore used advantageously with round oblong products, for example cables, pipes and profiles, which must be measured from all sides. Another possible area of use for the device according to the invention, however, is for the measuring of lengths of wide material, such as planks, plates and material webs. Several cameras are also provided in that case for an optimum detection, if possible, of the complete product width.

The cameras for the device according to the invention are arranged distributed, in particular evenly distributed, in a plane that is perpendicular to the longitudinal direction, as well as in longitudinal direction. The longitudinal direction thus represents a perpendicular direction to this plane.

The cameras are arranged distributed in this plane, around the longitudinal direction, such that they are positioned at the same distance to the oblong product to be measured. An oblong product of this type can otherwise also be called a long product.

As seen in longitudinal direction, the cameras are preferably arranged in a circle around the round, oblong product to be measured and/or moving in longitudinal direction. The plane formed by this circle extends perpendicular to the longitudinal direction, respectively to the longitudinal axis of the oblong product. The center of the circle in this case coincides with the center of the device (positioned in the aforementioned plane) and, provided the oblong product to be measured is in the correct position, also with the longitudinal axis of the oblong product that moves forward in longitudinal direction. The diameter of the circle depends on displacement of the cameras, relative to the center. The cameras in this case can be moved in radial direction, respectively can be moved back and forth.

According to a different preferred embodiment, the cameras are arranged uniformly distributed on the circle (more precisely: along the periphery of the circle). This type of embodiment is especially suitable for the above-described round products, wherein such a device is preferably used for measuring the surface defects on the round products.

For the measuring of products with a non-round cross section, using cameras which are arranged in a circle, it may be useful to configure the camera arrangement in such a way that the cameras can additionally also be displaced individually.

It is understood that the cameras can be secured in place in the selected displacement location.

If non-round, oblong products are to be measured, for example profiles, the cameras can alternatively also be positioned in an oval arrangement or a different geometrical configuration that is closed and which is positioned in the aforementioned perpendicular plane.

It is furthermore advantageous if the cameras are mounted on a joint holding device for the displacement, preferably on a flat area of the joint holding device, wherein this area is arranged perpendicular to the longitudinal axis in longitudinal direction.

With the method according to the invention for optically measuring and/or testing oblong products moving forward along their longitudinal direction, several cameras are displaced in the direction toward the surface of the oblong product to be measured, as described in the above, to a location at a distance to the oblong product to be measured, for which the oblong product is imaged with a sharp focus in the cameras. Of course, this operation takes place prior to the actual optical measuring and/or testing. Subsequently, the optical measuring and/or the testing are realized.

With this method, all cameras are consequently displaced jointly and simultaneously by the same distance in the direction toward the surface of the oblong product.

If there is mention within the scope of the present document of a displacement or movement in the direction toward the surface, this movement toward the surface can involve either a movement toward or away from the surface, depending on whether the cameras must be moved closer to the oblong product or away from it. The same is true for the displacement and/or movement in radial direction.

### BRIEF DESCRIPTION OF THE DRAWINGS

The invention is described in the following with the aid of a preferred device for measuring surface defects on cables, pipes and profiles. A device of this type is not shown true to scale in the following drawings, but is shown in part schematically with further details. The drawings show in:

FIG. 1 A perspective representation of a device according to the invention with three cameras;

FIG. 2 A view from above of the device shown in FIG. 1, as seen in longitudinal direction of the oblong product to be measured which is a pipe in this case;

FIG. 3 A view that is identical to the one shown in FIG. 2;

FIG. 4a A schematic representation of the optical configuration for conventional autofocus optics, as disclosed in the prior art;

FIG. 4b The optical configuration for a device according to the invention;

FIG. 5 The mode of operation of a device for displacing a camera;

FIG. 6 The device shown in FIG. 5 as seen from the side;

FIG. 7 An alternative embodiment of a device for displacing a camera; and

FIG. 8 A third embodiment of a device for displacing a camera.

### DETAILED DESCRIPTION

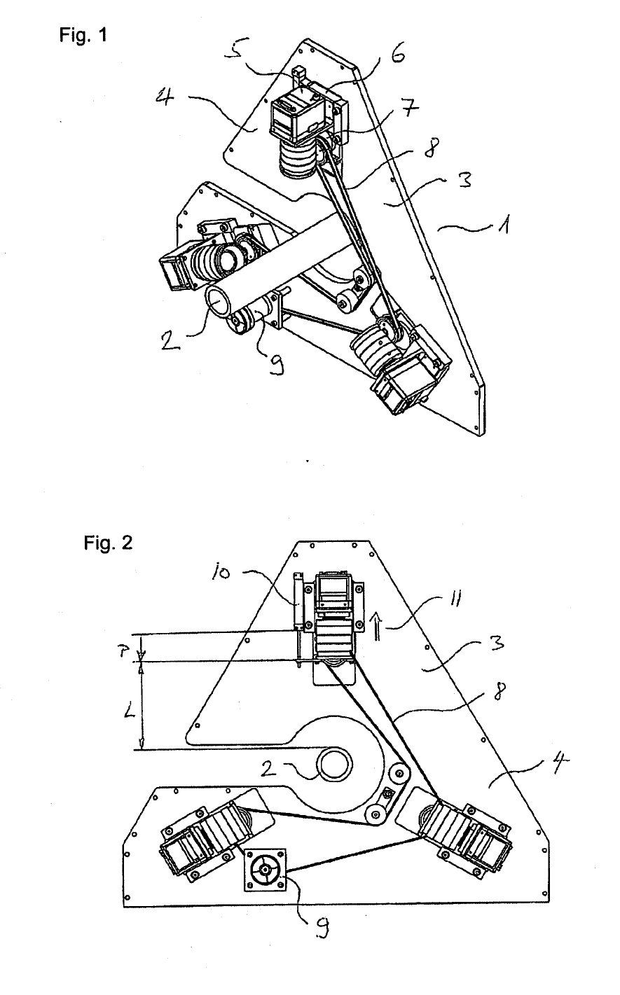

With reference to FIGS. 1 to 3, it is obvious that the inventive device 1 shown herein, which represents an exemplary and preferred embodiment, is provided with a base plate 3 that can carry all elements required for the measuring and/or testing.

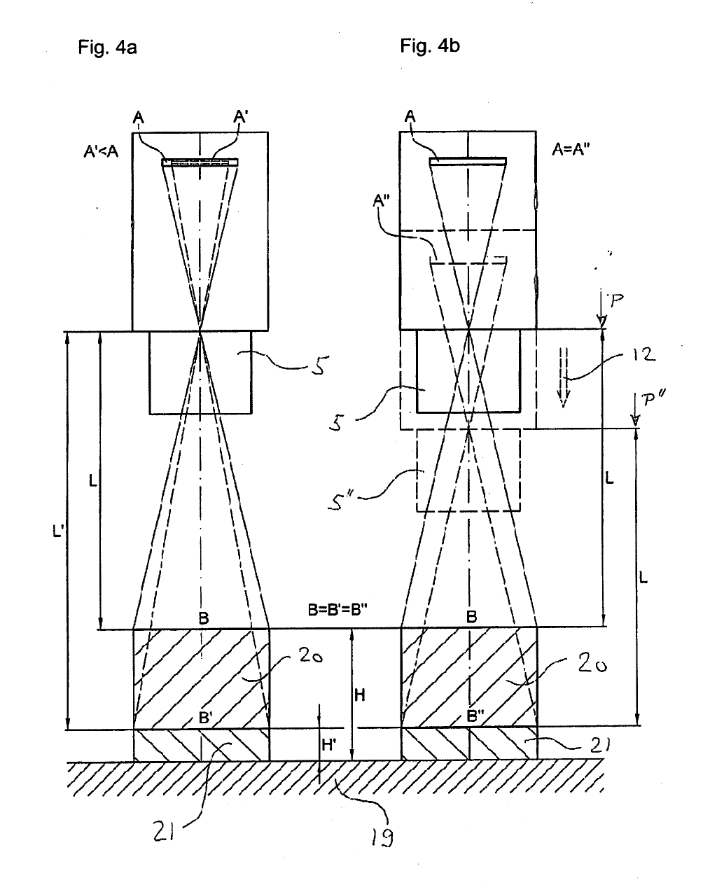

This base plate 3 represents the holding device for jointly holding three camera systems 4. The center of this approximately triangular-shaped base plate 3, as seen from above, contains an approximately circular recess 19 which is open toward the edge of the base plate 3 via a groove 22 (see FIG. 4b). As a result, it is possible to slide the base plate 3 in such a way onto the oblong product to be measured and tested, in this case a pipe 2, 2′, that the pipe 2, 2′ is arranged in the center and centered between the camera systems 4, wherein this will be discussed in further detail in the following.

The camera systems 4 are arranged uniformly distributed along the periphery of a circle, not shown herein, and point with their lenses toward the pipe 2, 2′. The center point of this virtual circle represents the center of the device 1 and coincides with the longitudinal center axis of the pipe 2, 2′, provided the pipe 2, 2′ is in the desired measuring position.

The device 1 is normally incorporated into a production line. The pipe 2, 2′ is continuously measured optically and tested for possible defects.

The diameter and the surface quality, for example, are parameters to be measured. In that case, optically detectable defects in color and form are measured, such as depressions, bulges, cracks, holes, impurities, striations, scratches, foreign bodies and many other things. The pipes 2, 2′ to be measured can be produced from any conceivable type of material, for example plastic, metal, glass and wood.

With the device 1 shown in the Figures, a total of three camera systems 4 are used to realize the measuring operation. However, it is also possible to use only one of these camera systems 4 if only specific parameters are to be measured.

A camera system 4 of this type includes the actual camera 5 which is mounted on a movable slide 6. This slide 6 can be displaced in radial direction and thus in the direction toward the longitudinal axis of the pipe 2, 2′, wherein differently designed devices can be used to achieve this displacement. The embodiment illustrated in FIGS. 1 to 3 uses an eccentric 7 for the displacement. This eccentric 7 can be driven directly by a motor 9. However, for the all-around monitoring of the illustrated pipe 2, 2′, several camera systems 4 can also be displaced simultaneously with the aid of a toothed belt 8 which engages in all the eccentrics 7. This type of arrangement will be discussed in further detail in the following with reference to FIGS. 5 to 9.

In FIG. 2, the device 1 according to the invention is shown in the “backward” position P. All three cameras 5 are displaced in radial direction away from the center of the device (located at the center of the aforementioned circle) to the radially outer position 11. In this position P, the device 1 according to the invention is adjusted optimally for the largest possible pipe 2 and is set to the focusing distance L, so that the surface to be tested appears as a sharp image in the camera. The position P of the camera 5 can be measured and determined with the aid of position sensors 10.

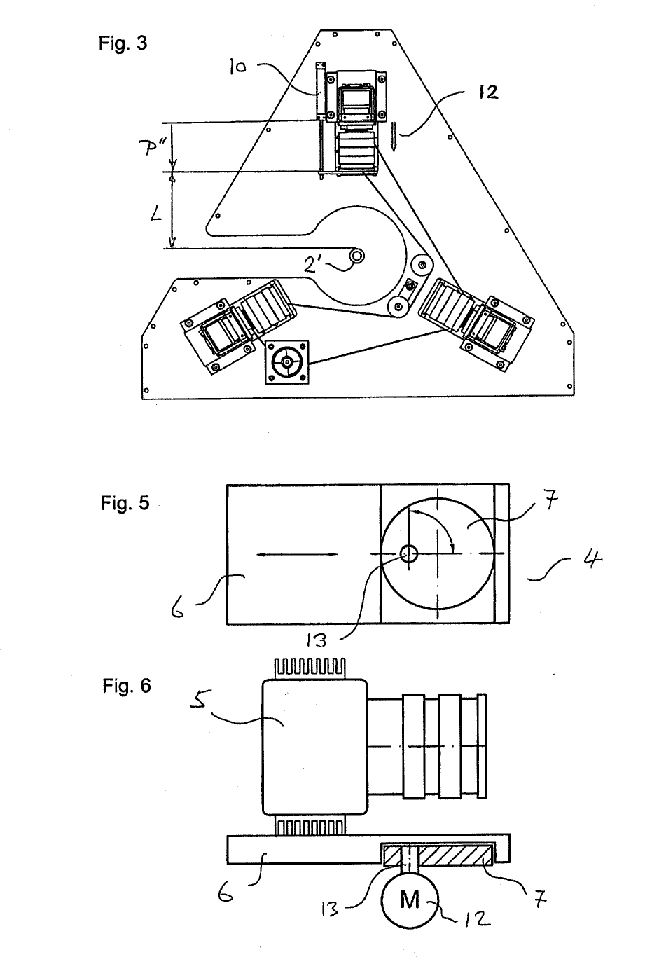

For the representation shown in FIG. 3, the device 1 according to the invention is located in the “forward” position P″. The cameras 5 are thus moved forward to the inner position 12 in radial direction. In other words, the cameras 5 are displaced toward the center, so that the surface of the pipe 2′, which represents a smaller sample or pipe than the larger pipe or sample 2 shown in FIG. 2, is again imaged with a sharp focus. The optimum distance L to the cameras 5 therefore remains constant. The position P″ can be determined with the aid of the aforementioned position sensors 10.

FIG. 4a shows the optical configuration for a device according to the prior art and/or a conventional device with autofocus optics, wherein lenses are used for setting the focus.

FIG. 4b is used to explain the focus setting according to the invention which does not require a changing of the optics. Instead, the complete camera is displaced.

This optical correlation is explained with the aid of a measurement of two flat samples 20 and 21 which have rectangular cross sections and different heights H and H′.

The following is true for FIG. 4a:

The sample 20 with the height H is imaged onto the sensor chip of the camera 5. In the process, the width in B is imaged as the length A. The lens of the camera 5 was focus-set precisely to the distance L.

For the sample 21 having the lower height H′, the camera 5 (more precisely the optics or lens system of this camera) must be focus-set precisely to the new distance L′. As a result, the imaging scale changes, so that the width B′ of the camera 5 appears shortened as A′. The two widths B and B′ are selected to be identical for this example. Expressed mathematically it means: B′=B from which follows A′<A.

The following is true for FIG. 4b:

With the device according to the invention, the same conditions result for the large sample 20 with the height H, as are shown in FIG. 4a. The camera 5 in this case is in the starting or backward position P. The width B is imaged with the corresponding length A. The distance L to the surface of the sample 20, 21 also corresponds to the focus setting according to FIG. 4a.

In contrast to the prior art shown in FIG. 4a, however, the focus setting 12 for the smaller sample 21 is achieved by displacing the camera 5 to the forward position P″ (shown with dashed lines). The optical configuration with a fixed distance L to the object to be measured is maintained for the imaging of B″. Accordingly, the length A″ imaged in this way is the same as the imaged length A of the sample B″ with identical width B. Mathematically expressed it means the following: B″=B, which results in A″=A.

It follows from the above explanations that with a conventional autofocus arrangement the imaging scale is different for each object distance. As a result, a true to scale measuring of the surface of the object is hardly possible. In contrast thereto, the imaging scale is clearly maintained for the device 1 according to the invention, so that a precise measuring is possible.

FIG. 5 shows how a camera system 4 according to the invention can be moved with the aid of an eccentric 7, wherein a shaft 13 drives this eccentric 7. The slide 6 on which the camera 5 is mounted is thus displaced in longitudinal direction, respectively in radial direction.

FIG. 6 provides a view from the side of the camera system 4, shown in FIG. 5, wherein the camera 5 is fixedly connected to the slide 6. The motor 12 drives the eccentric 7 via the shaft 13.

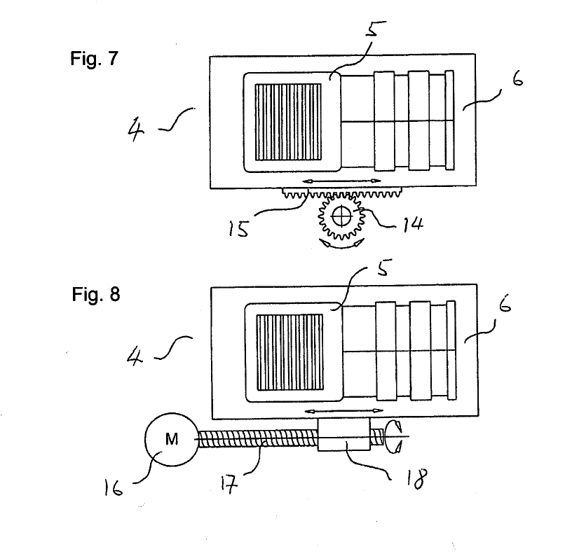

FIG. 7 also illustrates a different option for driving the slide, using a rack 15 and a gearwheel 14.

The slide 6 with thereon mounted camera 5, shown in FIG. 8, is driven with the aid of a motor-driven screw 17 which moves a nut 18, secured to the slide 6, in longitudinal direction.

In addition to the above-illustrated options for displacing the cameras 5 and/or the slides 6 on which these cameras 5 are mounted, it is also possible and is preferred according to the invention to displace or operate several camera systems 4 simultaneously. An embodiment of this type is illustrated in FIGS. 1 to 3. This embodiment comprises a motor 9 for simultaneously displacing and/or moving back and forth in radial direction the three cameras 4, shown in FIGS. 1 to 3, with the aid of a toothed belt 8. The toothed belt 8 for this embodiment engages in the eccentrics 7 of the three camera systems 4.

The device with three camera systems 4, shown in FIGS. 1 to 3, in particular functions to provide an all-around monitoring of a pipe 2, 2′.

Of course, it is also possible to combine several of the above-described devices for displacing the camera systems 4 in the direction toward the surface of the oblong products.

1. A device for optically measuring and/or testing oblong products moving in a longitudinal direction, said device comprising:
a plurality of cameras arranged in a plane perpendicular to the longitudinal direction, and distributed around the longitudinal direction, wherein each of the cameras has a fixed focus, and
a displacing device adapted to displace each of the cameras simultaneously and jointly over the same distance toward the surface of the oblong product to focus on the oblong product,
wherein the device defines a center that is located in the plane.

2. The device according to claim 1, wherein the cameras are arranged in a circle around the longitudinal direction, and the circle defines a center point that coincides with the center of the device.

3. The device according to claim 2, wherein the cameras are uniformly distributed along the circle for the cameras.

4. The device according to claim 1, wherein each camera is arranged on a moving slide.

5. The device according to claim 1, wherein the oblong products are round and define a longitudinal axis, and the cameras are adapted to be displaced perpendicular toward the surface of the oblong product in a radial direction toward the longitudinal axis.

6. The device according to claim 1, wherein the displacing device comprises a joint holding device.

7. The device according to claim 6, wherein the cameras are mounted on a planar surface of the joint holding device and are displaceable with respect to the joint holding device.

8. The device according to claim 1, wherein the cameras are adapted to be displaced individually and fixedly secured in a desired displacement position.

9. A method for optically measuring and/or testing oblong products, moving in a longitudinal direction, comprising:
providing a plurality of cameras each having a fixed focus,
prior to the measuring and/or testing the oblong object, moving all the cameras jointly and simultaneously over an equal distance toward the surface of the oblong product to be measured, to a location at a distance from the surface of the oblong product at which the oblong product is imaged with precise focus in each camera, and
subsequently measuring and/or testing the oblong product.
